(19) United States
(12) Patent Application Publication
(10) Pub. No.: US 2021/0387150 A1
(43) Pub. Date: Dec. 16, 2021

(54) MIXER

(71) Applicant: MAKITA CORPORATION, Anjo-shi (JP)

(72) Inventor: Ryohei HOTTA, Anjo-shi (JP)

(73) Assignee: MAKITA CORPORATION, Anjo-shi (JP)

(21) Appl. No.: 17/225,529

(22) Filed: Apr. 8, 2021

(30) Foreign Application Priority Data
Jun. 11, 2020 (JP) 2020-101835

(51) Int. Cl. B01F 15/00; B01F 7/00; F04D 25/06; H02K 5/20; H02K 7/00; H02K 7/116; H02K 9/06; H02K 11/00; H02K 11/33; H02K 21/14

(52) U.S. Cl. CPC B01F 15/00538; B01F 7/00725; B01F 15/00519; B01F 15/00461; F04D 25/06; H02K 5/207; B01F 2215/005; H02K 7/116; H02K 9/06; H02K 11/0094; H02K 11/33; H02K 21/14; B01F 2215/0047; H02K 7/003

(57) ABSTRACT

For vertical downsizing, a mixer includes a motor including a stator and a rotor, a motor housing accommodating the motor, a reducer driven by the rotor, a reducer housing below the motor housing and accommodating the reducer, a shaft holder protruding downward from the reducer housing to hold a mixer shaft, and a controller that controls the motor. The controller is vertically on the same level as the motor.

### CROSS-REFERENCE TO RELATED APPLICATIONS

This application claims the benefit of priority to Japanese Patent Application No. 2020-101835, filed on Jun. 11, 2020, the entire contents of which are hereby incorporated by reference.

### BACKGROUND

### 1. Technical Field

The present disclosure relates to a mixer for mixing fluid materials such as paint and mortar.

### 2. Description of the Background

A known mixer includes one or more blades rotating together with a mixer shaft to mix, for example, paint (refer to, for example, German Utility Model No. 202010014783, hereafter Patent Literature 1).

### BRIEF SUMMARY

Patent Literature 1 describes a mixer but does not describe control of a motor. A mixer additionally including a controller for controlling a motor can be easier to use. However, the positioning of the controller determines the dimensions of the mixer. The total vertical length of the mixer particularly affects operability.

Further, the mixer described in Patent Literature 1 includes the motor with its rotational shaft extending vertically in a motor housing, and has an inlet and an outlet located vertically apart from each other in the motor housing to let air in and out for cooling the motor. The mixer may have a longer total vertical length including the motor housing, or in other words, in the lengthwise direction of the mixer shaft, and may have lower operability.

One or more aspects of the present disclosure are directed to a mixer that can be downsized vertically.

A first aspect of the present disclosure provides a mixer for holding a mixer shaft, the mixer including:

a motor including a stator and a rotor;

a motor housing accommodating the motor;

a reducer driven by the rotor;

a reducer housing below the motor housing and accommodating the reducer;

a shaft holder protruding downward from the reducer housing to hold the mixer shaft; and

a controller configured to control the motor, the controller being vertically on the same level as at least a part of the motor.

A second aspect of the present disclosure provides a mixer for holding a mixer shaft, the mixer including:

a motor including a stator and a rotor;

a motor housing accommodating the motor;

a reducer driven by the rotor;

a reducer housing below the motor housing and accommodating the reducer;

a shaft holder protruding downward from the reducer housing to hold the mixer shaft; and

a controller configured to control the motor, the controller extending vertically in the motor housing.

A third aspect of the present disclosure provides a mixer for holding a mixer shaft, the mixer including:

a motor including a stator and a rotor;

a fan rotatable together with the rotor;

a motor housing accommodating the motor, the motor housing including
an inlet to draw in air in response to rotation of the fan, and
an outlet to discharge air in response to rotation of the fan, the outlet being vertically on the same level as at least a part of the inlet;

a reducer driven by the rotor;

a reducer housing below the motor housing and accommodating the reducer; and

a shaft holder protruding downward from the reducer housing to hold the mixer shaft.

The mixer according to the above aspects of the present disclosure can be downsized vertically.

### BRIEF DESCRIPTION OF DRAWINGS

FIG. 1 is an overall perspective view of a mixer including a mixer shaft and a blade.

FIG. 2 is a perspective view of a body of the mixer.

FIG. 3 is a plan view of the body of the mixer.

FIG. 4 is a rear view of the body of the mixer, partially showing in cross section.

FIG. 5 is a cross-sectional view taken along line A-A in FIG. 3.

FIG. 6 is an exploded perspective view of the body.

FIG. 7 is a cross-sectional view taken along line C-C in FIG. 5 without showing a handle.

FIG. 8 is a side view of the body with a battery cover open.

FIG. 9 is an exploded perspective view of the handle.

FIG. 10 is an enlarged sectional view taken along line B-B in FIG. 3.

FIG. 11 is a perspective view of the handle being attached to a motor housing.

FIG. 12 is a bottom view of a reducer housing.

FIG. 13 is a cross-sectional view of the mixer body taken along line D-D in FIG. 12 in a low speed mode.

FIG. 14 is a cross-sectional view of the mixer body taken along line E-E in FIG. 12 in the low speed mode.

FIG. 15 is a cross-sectional view of the mixer body in a high-speed mode.

### DETAILED DESCRIPTION

Embodiments of the present disclosure will now be described with reference to the drawings.

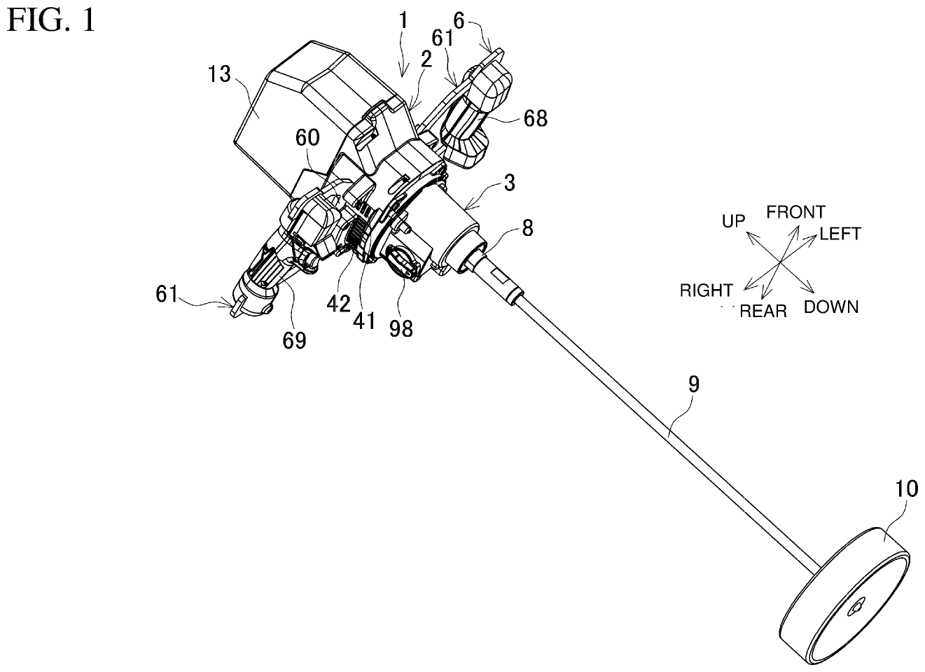

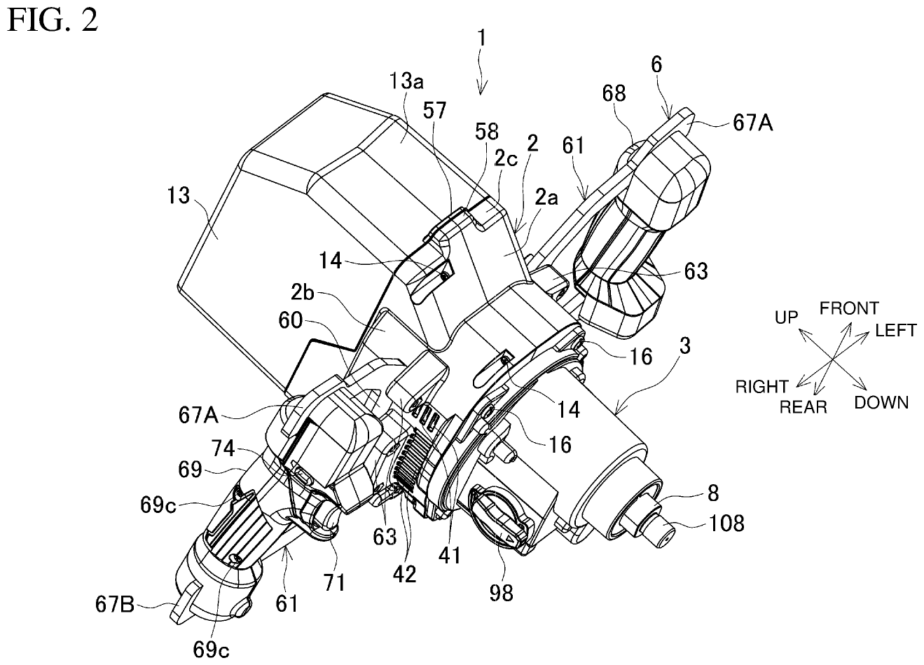

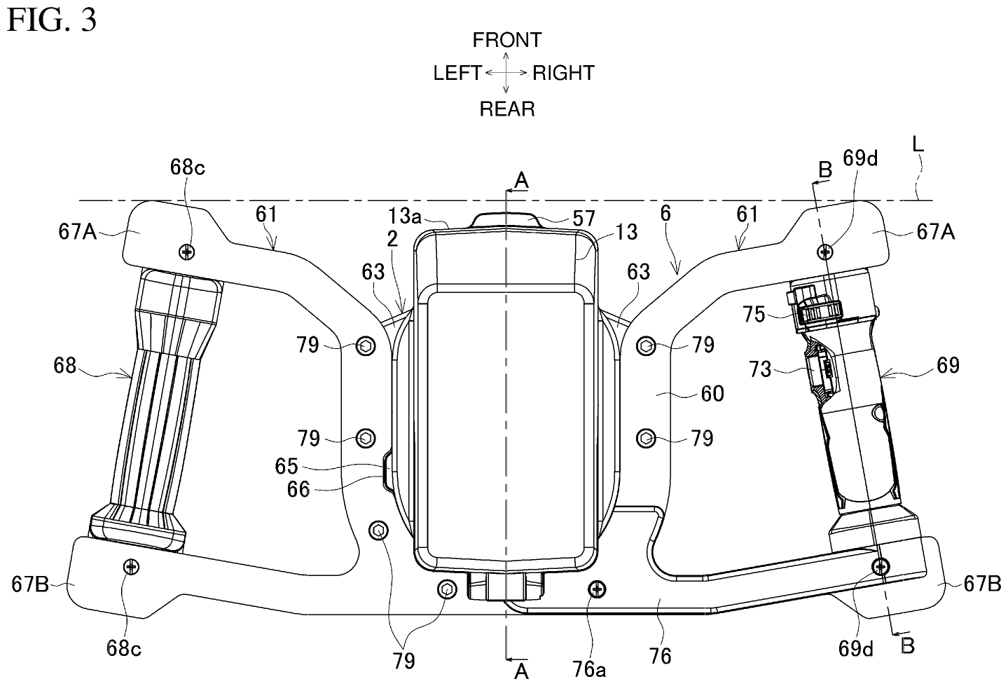

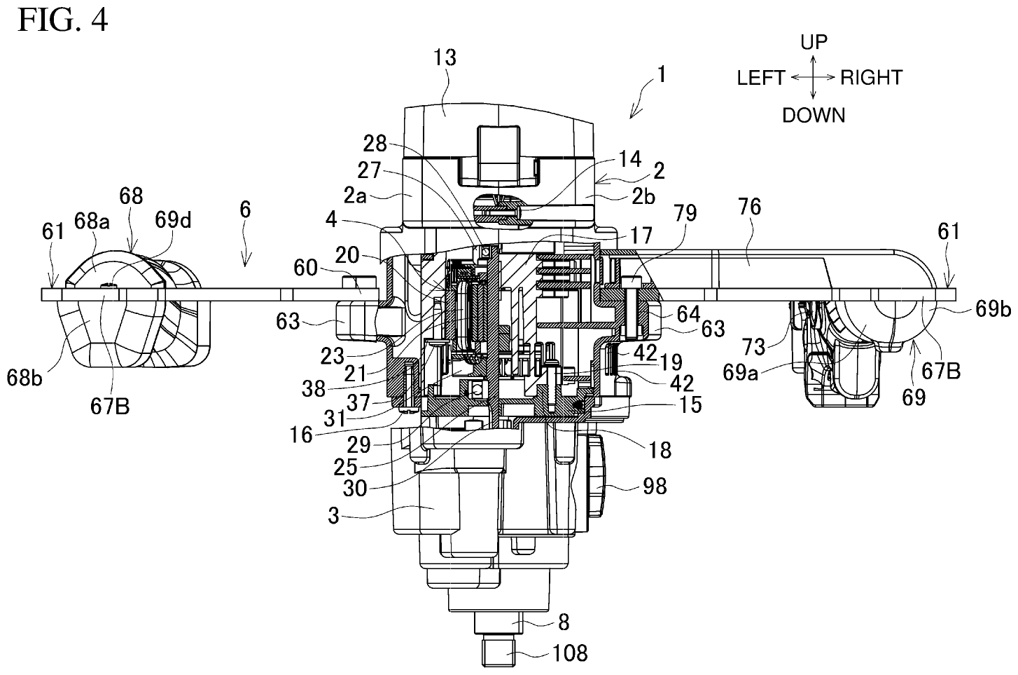

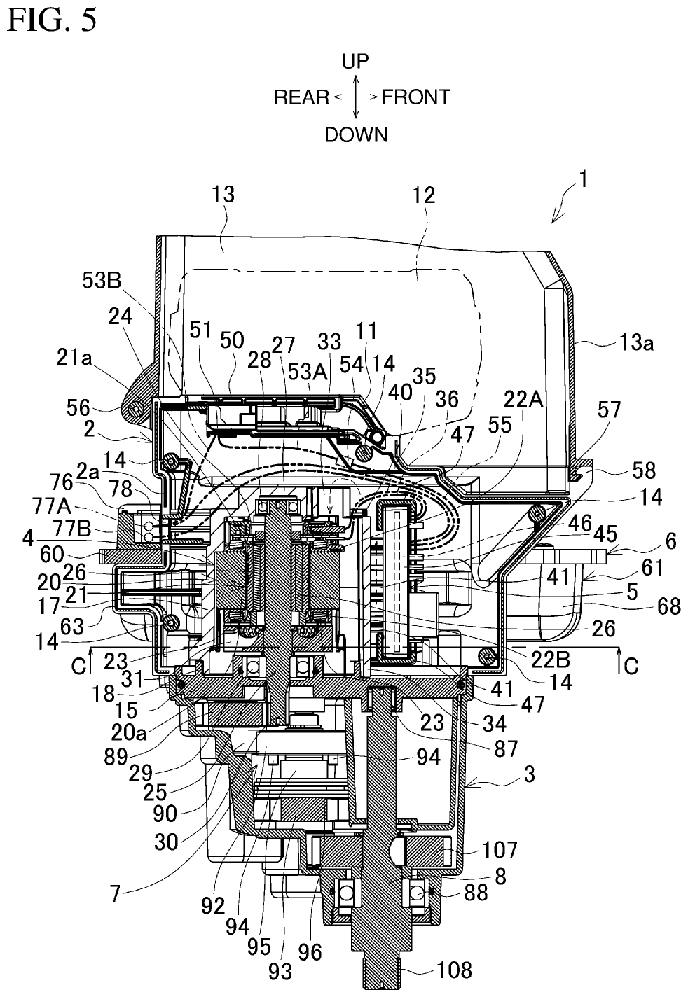

FIG. 1 is an overall perspective view of a rechargeable mixer 1 as an example of a mixer. FIG. 2 is a perspective view of a body of the mixer 1. FIG. 3 is a plan view of the body of the mixer 1. FIG. 4 is a rear view of the body of the mixer 1, partially showing in cross section. FIG. 5 is a cross-sectional view taken along line A-A in FIG. 3.

The mixer 1 includes the body including a motor housing 2 and a reducer housing 3. The motor housing 2 accommodates a motor 4 and a controller 5. A handle 6 is attached to the motor housing 2. The reducer housing 3 accommodates a reducer 7. The reducer 7 includes a spindle 8 to be an output shaft. The spindle 8 protrudes downward from the reducer housing 3. A mixer shaft 9 is coaxially connectable to the spindle 8. A blade 10 is attached to a lower end of the mixer shaft 9.

A battery mount 11 is located on an upper portion of the motor housing 2. A battery pack 12 is slidable onto the battery mount 11 from the front. A battery cover 13 is attached to the upper portion of the motor housing 2. The battery cover 13 covers the battery pack 12 and the battery mount 11 from above.

The motor housing 2 includes a pair of left and right half housings 2a and 2b. The half housings 2a and 2b are joined together with multiple screws 14 that are screwed from the right.

The motor housing 2 receives a disk-shaped bracket plate 15 on its lower end. The bracket plate 15 is fastened to the motor housing 2 together with the reducer housing 3 with multiple screws 16 from below.

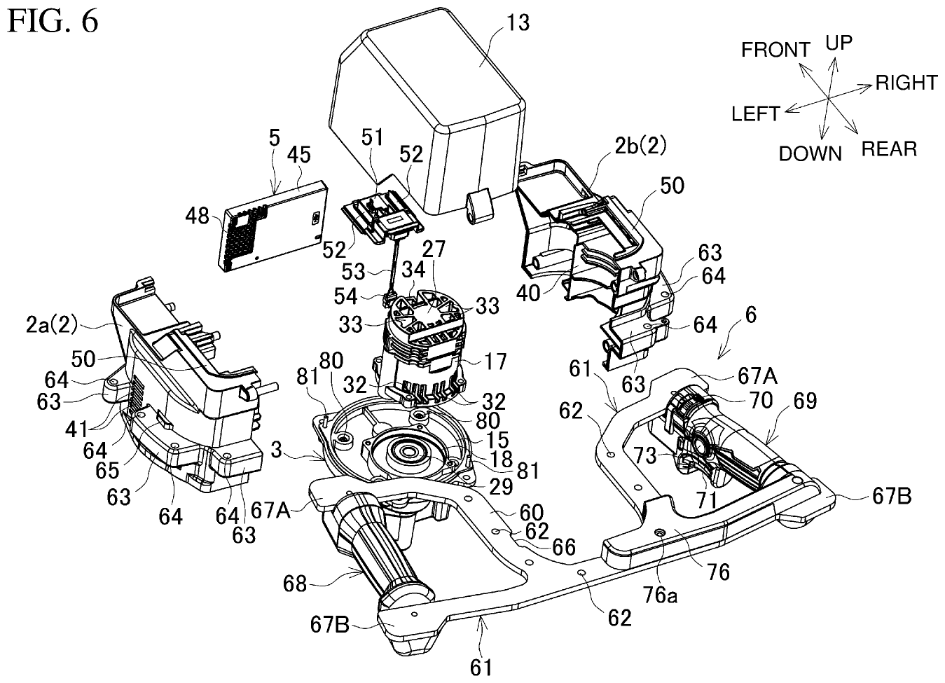

As shown in FIG. 6, the bracket plate 15 receives, on its upper side, a bottomed cylindrical inner housing 17 that is open downward. The inner housing 17 is an integral resin-molded part. The inner housing 17 accommodates the motor 4. The inner housing 17 is mounted on a mount 18 on the upper surface of the bracket plate 15 with four screws 19 (FIG. 4) screwed from above.

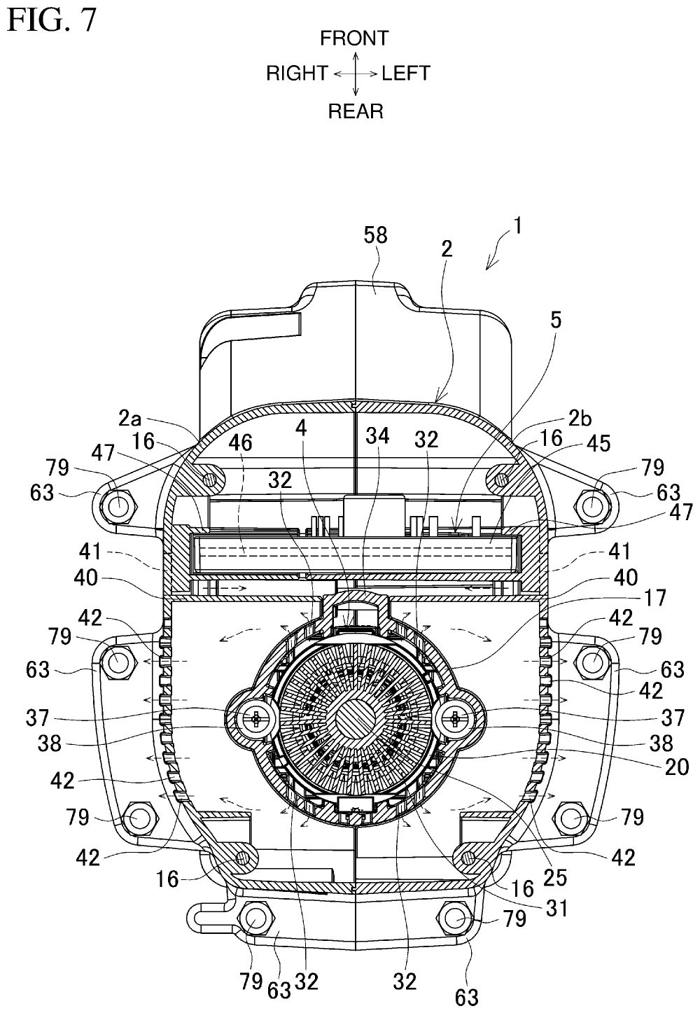

The motor 4 is a brushless motor. The motor 4 is an inner-rotor motor including an outer stator 20 and a rotor 21 inside the stator 20. The stator 20 is held in the inner housing 17 with its axis extending vertically. As shown in FIGS. 4 and 7, the stator 20 in the inner housing 17 is fixed in the axial direction with screws 37 screwed from below with washers 38 in between. The stator 20 has an upper portion fixed to the inner housing 17 in the rotation direction.

The stator 20 includes a stator core 20a, an upper insulator 22A, a lower insulator 22B, and multiple coils 23. The upper insulator 22A and the lower insulator 22B are fixed to the stator core 20a. The multiple coils 23 are wound around the upper insulator 22A and the lower insulator 22B. The upper and lower insulators 22A and 22B insulate each coil 23 from the stator core 20a. The coils 23 form a three-phase connection on the upper insulator 22A. A sensor circuit board 24 is attached to the upper insulator 22A. The sensor circuit board 24 includes a rotation detecting element (not shown). The rotation detecting element detects the positions of permanent magnets 26 included in the rotor 21.

The rotor 21 includes a rotational shaft 25, a rotor core 21a, and the permanent magnets 26. The rotational shaft 25 extends vertically through the stator 20. The rotor core 21a is fixed around the rotational shaft 25. The rotor core 21a has multiple holes extending in the axial direction each receiving the permanent magnet 26 in a fixed manner.

A bearing holder 27 is located on the upper end of the inner housing 17. The rotational shaft 25 has an upper end supported on a bearing 28 in a rotatable manner. The bearing 28 is held in the bearing holder 27. The rotational shaft 25 has a lower portion supported on a bearing 29 in a rotatable manner. The bearing 29 is held in the mount 18. The rotational shaft 25 has a lower end extending through the bracket plate 15 and protruding into the reducer housing 3. The rotational shaft 25 has the lower end with a pinion (gear) 30.

A fan 31 is located between the bearing 29 and the rotor core 21a on a lower portion of the rotational shaft 25. As shown in FIGS. 6 and 7, the inner housing 17 has, in its front and rear radially outward from the fan 31, multiple internal outlets 32. The internal outlets 32 extend radially through the inner housing 17. The internal outlets 32 are located at lower portions of the inner housing 17. The inner housing 17 has, on its upper portions and around the bearing holder 27, multiple internal inlets 33. The internal inlets 33 extend vertically through the inner housing 17.

As shown in FIGS. 5 to 7, a ridge 34 is located at the lateral center of the front surface of the inner housing 17. The ridge 34 extends vertically. The ridge 34 has an open upper end lower than the upper surface of the inner housing 17. As indicated with a two-dot chain line in FIG. 5, a three-phase power supply line 35 is directed outside the inner housing 17 through the ridge 34 in an upper portion of the inner housing 17. As indicated with a two-dot chain line, a signal line 36 connected to the sensor circuit board 24 for the rotation detecting element is also directed outside the inner housing 17 through the ridge 34 in an upper portion of the inner housing 17.

The motor housing 2 has a pair of right and left ribs 40 aligned with the ridge 34. The ribs 40 protrude inward from the inner surfaces of the half housings 2a and 2b toward the ridge 34. The ribs 40 are higher than the ridge 34 and lower than the inner housing 17. The ribs 40 each have an edge in contact with either the right side surface or the left side surface of the ridge 34. The ribs 40 separate the interior of the motor housing 2 except the inner housing 17 and the area above the motor 4 into front and rear areas.

The half housings 2a and 2b each have multiple external inlets 41 in their side surfaces and frontward from the ribs 40. The external inlets 41 are slits extending in the circumferential direction of the motor housing 2. As shown in FIGS. 2 and 6, the multiple external inlets 41 are apart from one another vertically at predetermined intervals. The half housings 2a and 2b each have multiple external outlets 42 in their side surfaces and rearward from the ribs 40. The external outlets 42 are slits extending vertically. The multiple external outlets 42 are apart from one another in the circumferential direction of the motor housing 2 at predetermined intervals. As shown in FIG. 2, the lowest two of the external inlets 41 apart vertically overlap the external outlets 42 apart in the circumferential direction of the motor housing 2. In other words, at least one of the external inlets 41 is on the vertically same level as the external outlets 42.

The controller 5 is located in front of the ribs 40 in the motor housing 2. The controller 5 extends vertically and laterally. The vertical length of the controller 5 is smaller than the vertical length of the rotational shaft 25. The controller 5 is thus vertically within the vertical dimension of the rotational shaft 25. In other words, the controller 5 is on the vertically same level as the motor 4.

The controller 5 includes a case 45 that accommodates a control circuit board 46. The case 45 is formed from aluminum, which provides high heat dissipation. The control circuit board 46 includes, for example, a microcomputer and multiple switching elements. The control circuit board 46 is accommodated in the case 45 with its mounting surface facing outward (frontward). As shown in FIGS. 5 and 7, the case 45 has its right and left edges held by support ribs 47. The support ribs 47 each protrude from the inner surface of either the half housing 2a or the half housing 2b. The right and left external inlets 41 are located outward from the right and left of the controller 5. A heat dissipator 48 having multiple recesses and protrusions (FIG. 6) is located on the rear surface of the case 45. The heat dissipator 48 is exposed from the support ribs 47 vertically (FIG. 5).

The battery mount 11 is located above the inner housing 17 and on the upper surface of the motor housing 2. The battery mount 11 includes a pair of right and left guide rails 50. The guide rails 50 each extend in the front-rear direction. The guide rails 50 receive, from the front, the battery pack 12 with its connection side facing downward. A terminal block 51 is located between the guide rails 50. Terminal strips 52 are located on the upper surface of the terminal block 51. The terminal strips 52 are electrically connectable to the attached battery pack 12. Lead wires 53A and 53B are directed outside from the lower surface of the terminal block 51.

The power supply line 35 and the signal line 36 from the motor 4 extend above the controller 5, are directed to the front of the controller 5, and then are connected to the front surface of the control circuit board 46. The lead wire 53A directed from the terminal block 51 is connected to the controller 5. The lead wire 53A is directed to above the inner housing 17 and the controller 5, and is then connected to a lead wire 55 directed from the front surface of the control circuit board 46 with a connector 54. The lead wire 53B directed from the terminal block 51 is connected to a switch 70 in the handle 6. The lead wire 53B above the inner housing 17 is directed rearward, then directed outside through a wiring hole 78 in the rear surface of the motor housing 2, and connected to a lead wire 77A from the switch 70.

The battery cover 13 is a box having an open lower end and is rectangular in a plan view. The battery cover 13 has a lower rear end pivotably connected to an upper rear end of the motor housing 2 with a screw 56 extending laterally.

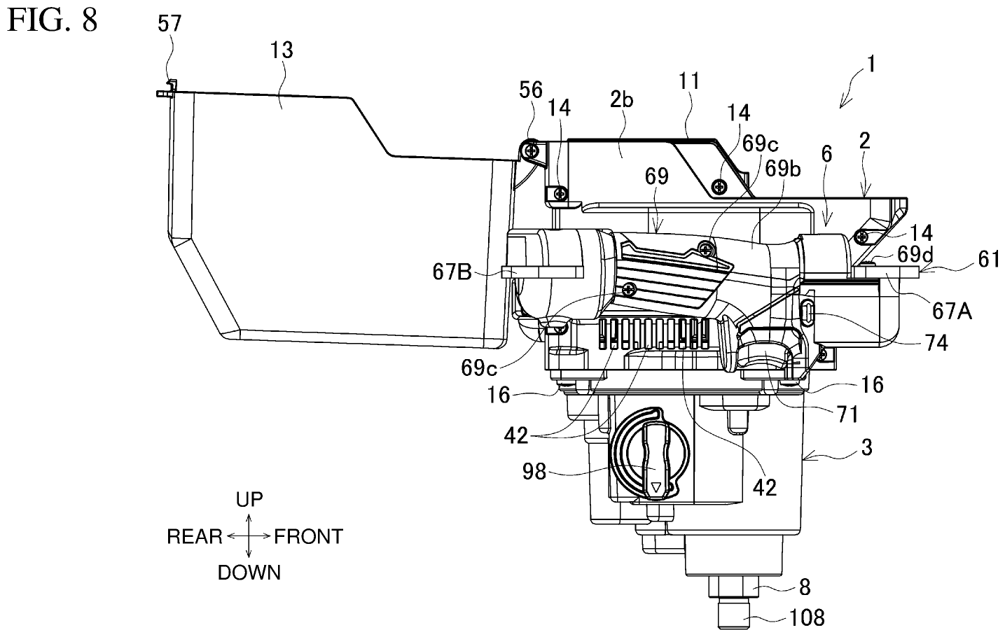

The battery cover 13 is pivotable about the screw 56 between a closed position and an open position. FIG. 5 shows the battery cover 13 at the closed position covering the battery pack 12 and the battery mount 11. FIG. 8 shows the battery cover 13 at the open position uncovering the battery pack 12 and the battery mount 11.

An engagement part 57 protrudes at the lower front end of the battery cover 13. A counter engagement part 58 is located at the upper front end of the motor housing 2. When the battery cover 13 is at the closed position, the engagement part 57 engages with the counter engagement part 58. The battery cover 13 at the closed position has a flat foremost surface 13a defined horizontally and vertically. The motor housing 2 excluding the counter engagement part 58 also has a flat foremost surface 2c defined horizontally and vertically. The foremost surface 2c of the motor housing 2 and the foremost surface 13a of the battery cover 13 are flush with each other vertically. As shown in FIG. 3, the battery cover 13 at the closed position has its right and left rear ends extending slightly outward from the motor housing 2 and partially overlapping the handle 6 vertically.

The handle 6 includes an attaching portion 60, a left grip 68, a right grip 69, and joints 61. The joints 61 connect the attaching portion 60 with the left and right grips 68 and 69. The attaching portion 60 is attached to the motor housing 2. The joints 61 are connected to the right and left of the attaching portion 60.

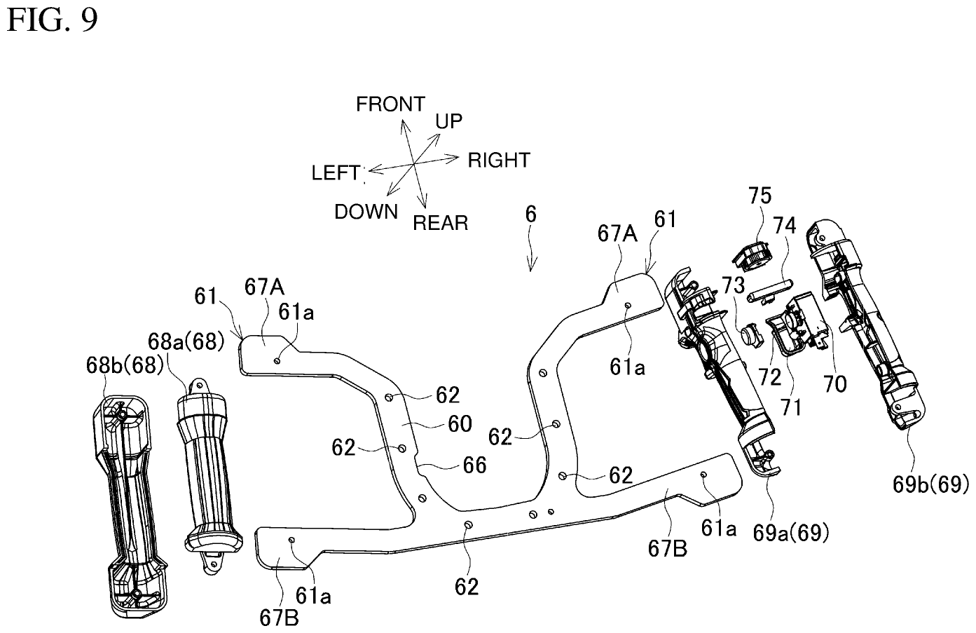

The attaching portion 60 is U-shaped in a plan view and is a vertically thin metal sheet. The joints 61 are metal sheets integral with the attaching portion 60. As shown in FIG. 9, the attaching portion 60 has multiple upper attachment holes 62 along its U-shaped portion. As shown in FIG. 6, the left and right half housings 2a and 2b each include three support protrusions 63 to support the attaching portion 60 from below. Each support protrusion 63 has one or more lower attachment holes 64. The lower attachment holes 64 correspond to the respective upper attachment holes 62 in the attaching portion 60. The half housing 2a includes a projection 65 above the middle support protrusion 63. The attaching portion 60 has a cutout 66 on its left inner edge. The projection 65 and the cutout 66 fit together to determine the lateral orientation of the handle 6.

Each joint 61 includes a pair of a front arm 67A and a rear arm 67B. Each front arm 67A is integral with and extends laterally outward from the front end of the attaching portion 60. Each rear arm 67B is integral with and extends laterally outward from the rear end of the attaching portion 60. The left front arm 67A is referred to as a front arm 67LA, and the left rear arm 67B as a rear arm 67LB. The right front arm 67A is referred to as a front arm 67RA, and the right rear arm 67B as a rear arm 67RB.

The left grip 68 extends between the left edges of the left front and rear arms 67LA and 67LB. The right grip 69 extends between the right edges of the right front and rear arms 67RA and 67RB. As shown in FIG. 9, the left grip 68 is dividable into an upper half part 68a and a lower half part 68b by a plane extending in the front-rear direction. The front and rear ends of the half parts 68a and 68b are fastened together in through-holes 61a in the left edges of the front and rear arms 67LA and 67LB with screws 68c. The left grip 68 is hollow and is shaped to be gripped by an operator.

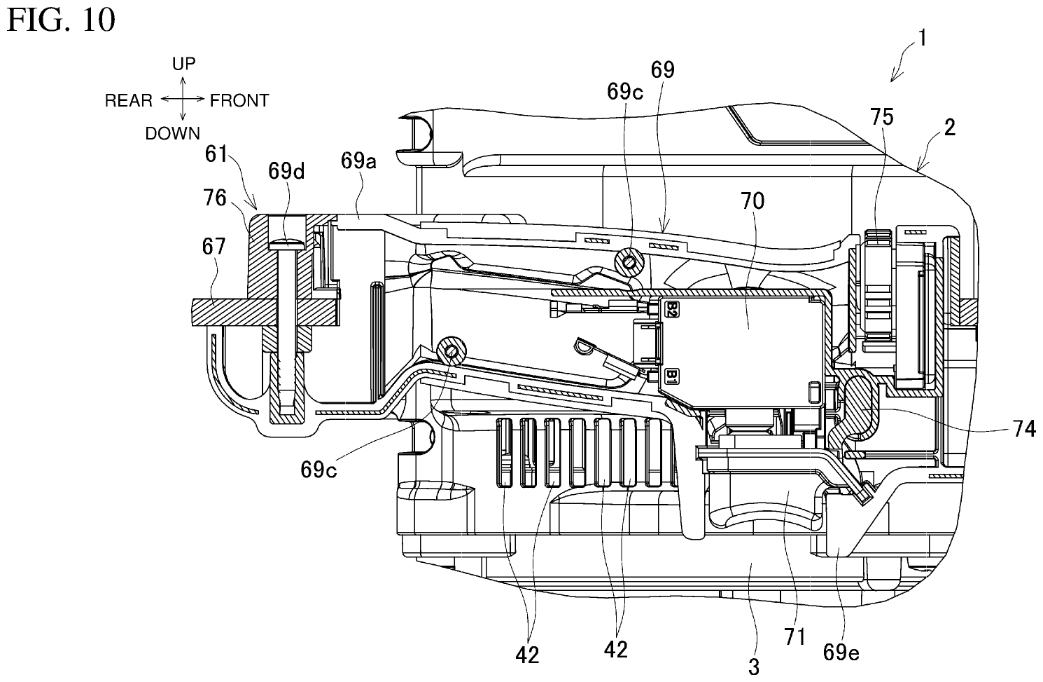

The right grip 69 is dividable into a left half part 69a and a right half part 69b by a plane extending in the front-rear direction. As shown in FIGS. 8 and 10, the half parts 69a and 69b are joined together with screws 69c extending laterally. The front and rear ends of the right grip 69 are fastened in through-holes 61a in the right edges of the front and rear arms 67RA and 67RB with screws 69d.

As shown in FIGS. 9 and 10, the left and right half parts 69a and 69b in the right grip 69 incorporate multiple components including the switch 70, a trigger 71, a lock button 72, a button cover 73, a lock lever 74, and an adjustment dial 75.

The switch 70 is located inside the half parts 69a and 69b with the trigger 71 protruding downward. The trigger 71 is exposed from an opening periphery 69e on the lower surface of the right grip 69. The opening periphery 69e is located downward from the lower surface of the trigger 71.

The lock button 72 is located on the left side surface of the switch 70. The lock button 72 locks the trigger 71 being pressed. The button cover 73 for the lock button 72 protrudes from the right grip 69. The lock button 72 is exposed from the left side surface of the right grip 69 to be operable by an operator.

The lock lever 74 is located in front of the switch 70. The lock lever 74 is slidable between a position at which the trigger 71 is prevented from being pressed and a position at which the trigger 71 is allowed to be pressed. The lock lever 74 is exposed from the right side surface of the right grip 69 to be operable by an operator.

The adjustment dial 75 is located in front of the lock lever 74. The adjustment dial 75 is rotated to adjust the rotational speed of the motor 4. The adjustment dial 75 is exposed from the right grip 69 to be operable by an operator.

A lead wire cover 76 is fastened to the upper surfaces of the rear arm 67RB in the right joint 61 and the attaching portion 60 with a screw 76a. As shown in FIG. 5, the lead wires 77A and 77B are directed into the lead wire cover 76. The lead wire 77A is connected to the switch 70 in the right grip 69. The lead wire 77B is connected to a substrate for the adjustment dial 75. The lead wires 77A and 77B are first directed from the front to the rear in the right grip 69 and then directed outside the right grip 69. The lead wires 77A and 77B then extend through a vertical space between the lead wire cover 76 and the rear arm 67RB to be directed from the right to the left. The lead wires 77A and 77B are then directed into the motor housing 2 through the wiring hole 78 in the rear surface of the motor housing 2. As indicated with a two-dot chain line in FIG. 5, the lead wire 77A for the switch 70 extends above the inner housing 17 and is connected to the front surface of the control circuit board 46 and to the lead wire 53B for the terminal block 51. As indicated with a two-dot chain line in FIG. 5, the lead wire 77B for the adjustment dial 75 extends above the inner housing 17 and is directed to the front surface of the control circuit board 46.

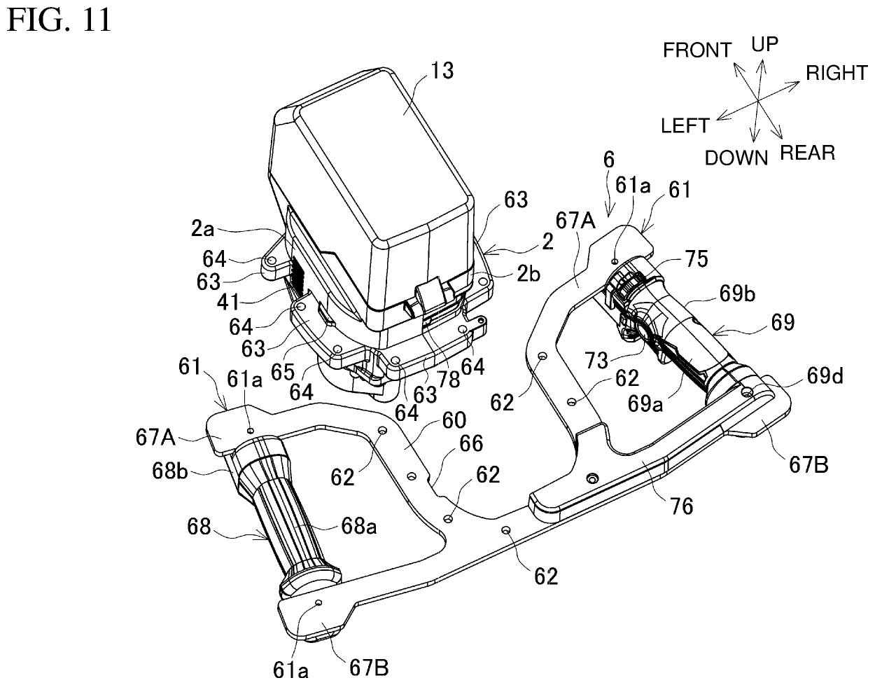

As shown in FIG. 11, the attaching portion 60 in the handle 6 is mounted on the support protrusions 63 from the upper rear of the motor housing 2 with the opening of the U-shaped attaching portion 60 facing frontward. The cutout 66 is fitted to the projection 65. Subsequently, bolts 79 are placed through the respective upper attachment holes 62 and then through the respective lower attachment holes 64 from above, and are tightened with nuts. The handle 6 is thus fixed to the motor housing 2 as shown in FIG. 3. With the handle 6 fixed, the motor housing 2 and the battery cover 13 have their front surfaces rearward from a dot-and-dash straight line L extending laterally that connects the front edges of the left and right joints 61. The attaching portion 60 has its rear edge rearward from the rear surfaces of the motor housing 2 and the battery cover 13. The motor housing 2 and the battery cover 13 can be easily attached to the attaching portion 60 without being inserted through the attaching portion 60.

As shown in FIGS. 4, 7, and 8, the reducer housing 3 is fixed to the lower surface of the motor housing 2 with the four screws 16 from below. As shown in FIG. 6, the reducer housing 3 is fixed to the bracket plate 15 with four screws 80 from above. As shown in FIG. 6, the reducer housing 3 includes, on its upper surface, four pins 81 protruding upward. The pins 81 pass through the bracket plate 15 and are placed into the lower surface of the motor housing 2.

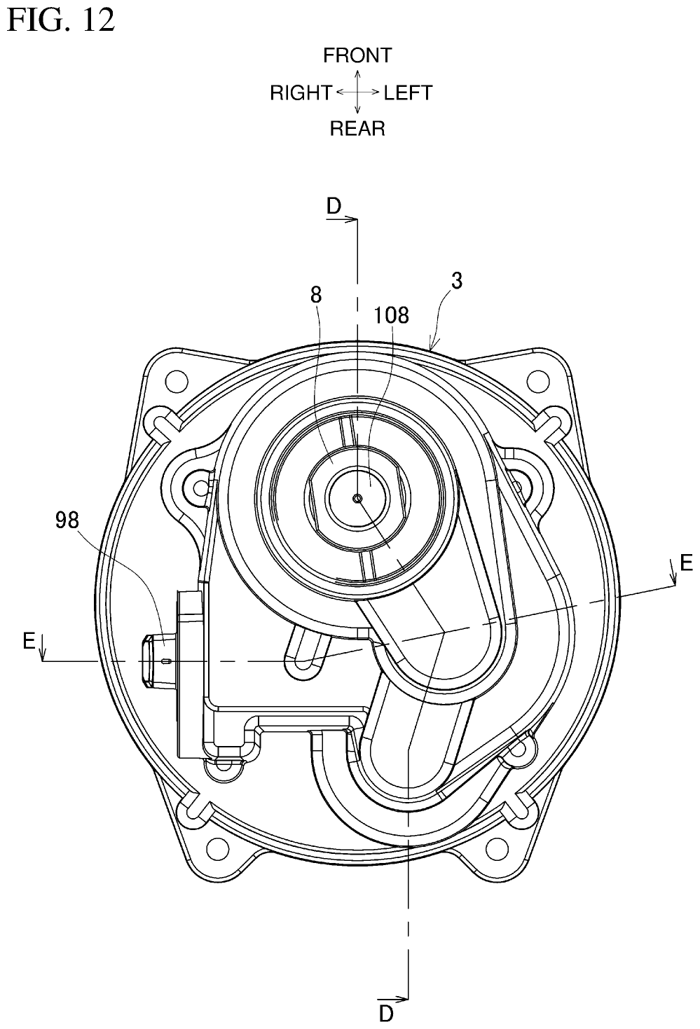

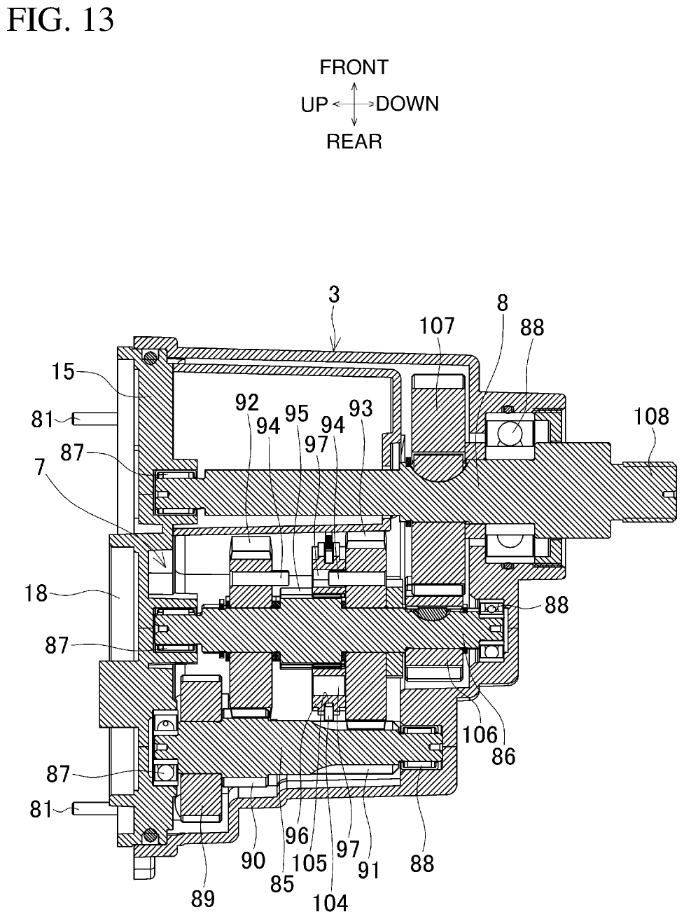

As shown in FIGS. 12 and 13, the reducer 7 includes a first shaft 85, a second shaft 86, and the spindle 8. The first shaft 85, the second shaft 86, and the spindle 8 extend vertically. The first shaft 85 is at the rearmost position. The spindle 8 is at the foremost position. The second shaft 86 is between the first shaft 85 and the spindle 8. The first and second shafts 85 and 86 and the spindle 8 have their upper ends supported by bearings 87. The bearings 87 are held on the bracket plate 15. The first and second shafts 85 and 86 and the spindle 8 have their lower ends supported by bearings 88. The bearings 88 are held on the reducer housing 3.

The first shaft 85 includes an input gear 89 on its upper portion. The input gear 89 meshes with the pinion 30 on the rotational shaft 25. The first shaft 85 receives a first driving gear unit 90 and a second driving gear unit 91 with different diameters and different numbers of teeth on its upper and lower portions below the input gear 89.

The second shaft 86 includes a first follower gear 92 and a second follower gear 93. The first follower gear 92 and the second follower gear 93 are separately rotatable. The first follower gear 92 is above the second follower gear 93. The first follower gear 92 meshes with the first driving gear unit 90 on the first shaft 85. The second follower gear 93 with a larger diameter than the first follower gear 92 meshes with the second driving gear unit 91 on the first shaft 85. Multiple connecting pins 94 are located on the first follower gear 92 and the second follower gear 93. Each connecting pin 94 on either the first follower gear 92 or the second follower gear 93 protrudes toward a surface of another connecting pin 94 facing the connecting pin 94.

The second shaft 86 has a splined part 95 between the first follower gear 92 and the second follower gear 93. A speed switch ring 96 is located on the splined part 95 in a manner rotatable together with the splined part 95 and movable in the axial direction. The speed switch ring 96 has multiple through-holes 97. Each through-hole 97 can receive the connecting pin 94 from above and below. The connecting pins 94 on the first follower gear 92 are placed in the through-holes 97 at upper positions of the speed switch ring 96. This enables a high-speed mode in which the rotation of the first follower gear 92 is transmitted to the second shaft 86 via the speed switch ring 96. The connecting pins 94 on the second follower gear 93 are placed in the through-holes 97 at lower positions of the speed switch ring 96. This enables a low-speed mode in which the rotation of the second follower gear 93 is transmitted to the second shaft 86 via the speed switch ring 96.

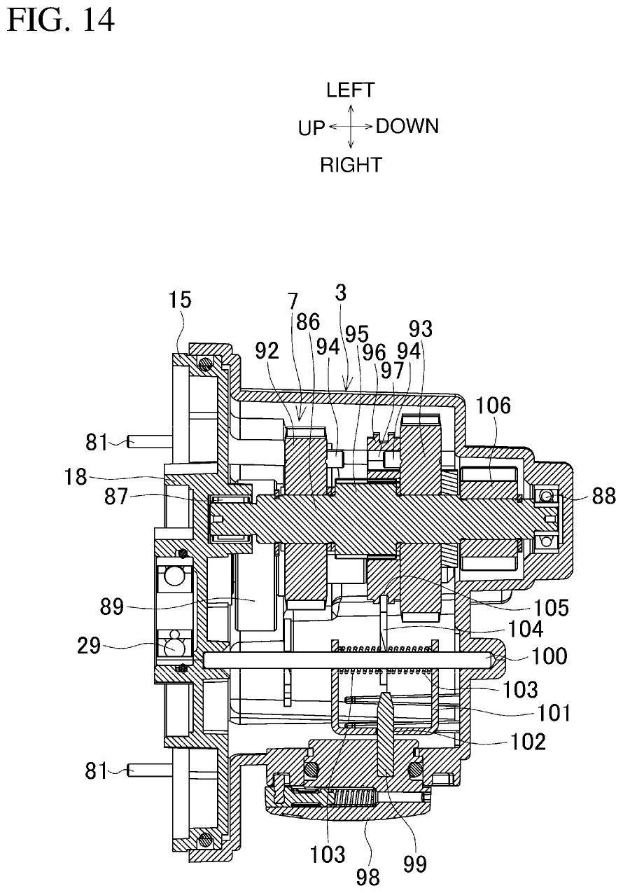

As shown in FIG. 14, a switch lever 98 on the right side surface of the reducer housing 3 can change the vertical position of the speed switch ring 96. The switch lever 98 on the reducer housing 3 is rotatable. The switch lever 98 has an eccentric pin 99 at a position decentered from its rotation center. The eccentric pin 99 protrudes into the reducer housing 3. A guide pin 100 extends vertically across the reducer housing 3 between the switch lever 98 and the second shaft 86. The guide pin 100 extends through the upper and lower ends of a change plate 101, which is U-shaped in a side view. The change plate 101 is vertically slidable along the guide pin 100. The change plate 101 has a slit 102 with a length allowing the eccentric pin 99 to move laterally as the switch lever 98 rotates. The eccentric pin 99 extends through the slit 102. When the switch lever 98 is rotated, the change plate 101 moves vertically as the eccentric pin 99 moves.

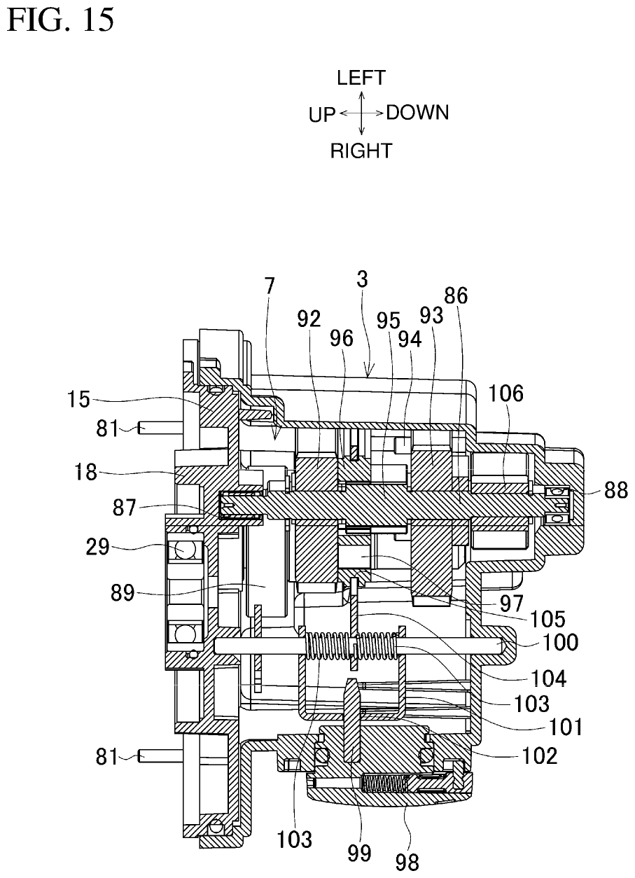

A pair of coil springs 103 are externally mounted on the guide pin 100 inside the change plate 101. A change ring 104 is held between the coil springs 103. The guide pin 100 extends through the change ring 104. The change ring 104 engages with a ring groove 105 on the outer periphery of the speed switch ring 96. When the change plate 101 moves vertically, the change ring 104 held between the coil springs 103 moves vertically accordingly to cause the speed switch ring 96 to move vertically. Thus, the mode is switchable between the high-speed mode and the low-speed mode by rotating the switch lever 98 and thus changing the vertical position of the speed switch ring 96. FIGS. 13 and 14 show the low-speed mode in which the speed switch ring 96 is moved downward to connect to the second follower gear 93. FIG. 15 shows the high-speed mode in which the speed switch ring 96 is moved upward to connect to the first follower gear 92.

The second shaft 86 receives an intermediate gear 106 on its lower portion in a manner rotatable together with the second shaft 86. The spindle 8 receives an output gear 107 on its lower portion in a manner rotatable together with the spindle 8. The output gear 107 meshes with the intermediate gear 106.

The rotation of the rotational shaft 25 of the motor 4 is reduced while being transmitted to the first shaft 85 via the input gear 89 in the reducer 7. The rotation of the first shaft 85 is reduced in the high-speed mode through the first driving gear unit 90 and the first follower gear 92 while being transmitted to the second shaft 86. The rotation of the first shaft 85 is reduced in the low-speed mode through the second driving gear unit 91 and the second follower gear 93 while being transmitted to the second shaft 86. The rotation of the second shaft 86 is transmitted to the spindle 8 through the intermediate gear 106 and the output gear 107.

The spindle 8 has the lower end extending through the reducer housing 3 to protrude downward. The spindle 8 receives a shaft holder 108 at the lower end. The shaft holder 108 is connectable with the upper end of the mixer shaft 9 with a screw.

An operator grips the left grip 68 and the right grip 69 in the handle 6 in the mixer 1 with the above structure with the battery pack 12 attached. The mixer 1 is thus held with the mixer shaft 9 protruding downward. This posture is normally taken in operation. For an operator with a certain height or due to another factor, the mixer shaft 9 may not extend vertically downward. For example, the mixer shaft 9 may be inclined to have the upper portion rearward and the lower portion frontward. In this case, the lengthwise direction of the mixer shaft 9 is defined as the vertical direction.

When the operator presses the trigger 71 in the right grip 69, the switch 70 is turned on. The microcomputer in the control circuit board 46 then determines the rotational position of the rotor 21 based on a detection signal from the sensor circuit board 24, and causes the six switching elements (e.g., a metal-oxide-semiconductor field-effect transistor, or MOSFET, and an insulated gate bipolar transistor, or IGBT) to perform the switching operation. This supplies a three-phase current to the stator 20, energizing the coils 23 sequentially to rotate the rotor 21. When the rotational shaft 25 rotates together with the rotor 21, the rotation of the rotational shaft 25 is reduced by the reducer 7 in the high-speed mode or the low-speed mode as selected by the switch lever 98, while being transmitted to the spindle 8. This causes the mixer shaft 9 connected with the shaft holder 108 to rotate integrally with the spindle 8. The blade 10 rotates together with the mixer shaft 9 to allow mixing of a paint or another material.

In the present embodiment, the button cover 73 (lock button 72) and the adjustment dial 75 greatly improve usability. More specifically, the lock button 72 is operable to allow the motor 4 to remain rotating without operating the trigger 71. Then, the operator can adjust the rotation of the motor 4 in accordance with the viscosity of the paint or the material being mixed simply by operating the adjustment dial 75. When the operation is complete, the lock button 72 is operated to stop the rotation of the motor 4.

In operation, the operator gripping the left and right grips 68 and 69 to support the mixer 1 views, from above the motor housing 2 and the battery cover 13, for example, the blade 10 on the lower end of the mixer shaft 9, the mixer shaft 9, and the material being mixed. In this state, the attaching portion 60 in the handle 6, which is not in front of the motor housing 2 and the battery cover 13, can avoid obstructing the operator's field of view. The operator can thus reliably view, for example, the blade 10.

The motor 4 and the controller 5 in the motor housing 2 are on the vertically same level. The external inlets 41 and the external outlets 42 are also on the same level. The motor housing 2 can thus be downsized vertically, improving the operability of the mixer 1.

The fan 31 rotates as the rotational shaft 25 rotates. This draws the outside air into the motor housing 2 through the right and left external inlets 41 in the motor housing 2. As indicated with dotted arrows in FIGS. 5 and 7, this airflow passes between the controller 5 and the ribs 40 to come in contact with the case 45 (heat dissipator 48). The airflow then rises and moves above the ribs 40 and rearward. The airflow then enters the inner housing 17 through the internal inlets 33 in the inner housing 17. The airflow then moves downward in the inner housing 17 to cool the motor 4. The airflow then exits through the front and rear internal outlets 32 in the inner housing 17 into the motor housing 2. The airflow then diverges into right and left airflows and is discharged through the right and left external outlets 42 in the motor housing 2.

The airflow thus cools the controller 5 upstream and the motor 4 downstream. The ribs 40 and the ridge 34 separating the controller 5 and the motor 4 allow the airflow to sequentially cool the controller 5 and the motor 4 without any shortcut, although the external inlets 41 and the external outlets 42 are on the same level.

The mixer 1 according to the present embodiment includes the motor 4 including the stator 20 and the rotor 21, and the motor housing 2 accommodating the motor 4. The mixer 1 further includes the reducer 7 drivable by the rotor 21, and the reducer housing 3 located below the motor housing 2 and accommodating the reducer 7. The mixer 1 further includes the shaft holder 108 protruding downward from the reducer housing 3 to hold the mixer shaft 9, and the controller 5 (controller) controlling the motor 4. The controller 5 is on the vertically same level as the motor 4.

This structure allows the motor housing 2 to be downsized vertically, and thus allows the mixer 1 to be downsized vertically.

At least a part of the controller 5 may be on the vertically same level as at least a part of the motor 4. For the controller 5 located upward and the motor 4 downward, for example, the lower end of the controller 5 and the upper end of the motor 4 may be on the same level, or the upper end of the controller 5 and the lower end of the motor 4 may be on the same level. For the inclined mixer 1, being vertically on the same level refers to being on the corresponding front or rear position in the lengthwise direction of the mixer shaft 9.

The rotor 21 includes the rotational shaft 25. The motor 4 is accommodated in the motor housing 2 with the rotational shaft 25 extending vertically. The motor housing 2 can thus be smaller in the front-rear direction and the lateral direction.

The controller 5 extending vertically is accommodated in the motor housing 2. This can save space horizontally when the controller 5 and the motor 4 are located on the same level. This also allows the airflow to be on the controller 5 for a longer period of time, thus achieving effective cooling.

The controller 5 is vertically within the vertical dimension of the rotational shaft 25, allowing the motor housing 2 to remain downsized vertically.

The mixer 1 includes the fan 31 rotatable together with the rotor 21. The motor housing 2 includes the external inlets 41 (inlets) for drawing in air by the rotation of the fan 31, and the external outlets 42 (outlets) for discharging air by the rotation of the fan 31. The external inlets 41 and the external outlets 42 are vertically on the same level.

The motor housing 2 is thus smaller vertically than a motor housing with the external inlets 41 and the external outlets 42 vertically apart. The motor housing 2 is thus downsized vertically.

The controller 5 is located to receive an airflow from the external inlets 41 to the external outlets 42. The controller 5 can thus be cooled through the external inlets 41 and the external outlets 42 vertically on the same level.

The motor 4 is downstream in the airflow. The controller 5 is upstream in the airflow. The motor 4 and the controller 5 are thus cooled efficiently.

The motor 4 and the controller 5 are separated by the ribs 40 that define the path of the airflow. The motor 4 and the controller 5 can thus be reliably cooled when the external inlets 41 and the external outlets 42 are vertically on the same level.

The mixer 1 according to the present embodiment includes the motor 4 including the stator 20 and the rotor 21, and the motor housing 2 accommodating the motor 4. The mixer 1 further includes the reducer 7 drivable by the rotor 21, and the reducer housing 3 located below the motor housing 2 and accommodating the reducer 7. The mixer 1 further includes the shaft holder 108 protruding downward from the reducer housing 3, drivable by the reducer 7, and holding the mixer shaft 9. The mixer 1 further includes the handle 6 including the metal attaching portion 60 attachable to the motor housing 2 and a pair of the left and right grips 68 and 69 (grips) connected to the left and right of the attaching portion 60. The handle 6 is not located frontward from the motor housing 2 (a frontal plane onto which the motor housing 2 is projected with a parallel projection).

In this structure, the attaching portion 60 has a central portion that does not extend frontward from the motor housing 2. This structure reliably provides visibility for the operator to easily view, for example, the blade 10 from above.

The motor housing 2 can be attached to the attaching portion 60 without being inserted through the attaching portion 60. The handle 6 can thus be attached easily.

The attaching portion 60 is U-shaped in a plan view. The attaching portion 60 can thus be attached to the motor housing 2 easily.

The foremost surface 2c (front surface) of the motor housing 2 does not protrude frontward from the front edges of the pair of joints 61 (front edge of the handle 6). The motor housing 2 at this position does not obstruct the operator's field of view, further improving visibility.

The motor housing 2 has the flat foremost surface 2c defined horizontally and vertically. The motor housing 2 with this shape does not obstruct the operator's field of view, further improving visibility.

The attaching portion 60 integrally includes, on its left and right, the joints 61 including pairs of the metal front arms 67A and the metal rear arms 67B (arms) extending leftward and rightward. The left and right grips 68 and 69 as the grips each extend between the edges of the corresponding front and rear arms 67A and 67B in the joints 61. The handle 6 is thus easy to grip.

The left grip 68 is dividable into the upper half part 68a and the lower half part 68b by a plane extending in the front-rear direction being the extension direction of the left grip 68 extending between the edges of the front and rear arms 67A and 67B. The right grip 69 is dividable into the left half part 69a and the right half part 69b by a plane extending in the front-rear direction being the extension direction of the right grip 69 extending between the edges of the front and rear arms 67A and 67B. The front and rear ends of the half parts 68a and 68b are fastened to the edges of the front and rear arms 67A and 67B with screws. The front and rear ends of the half parts 69a and 69b are fastened to the edges of the front and rear arms 67A and 67B with screws. The left and right grips 68 and 69 are thus easily attachable.

The attaching portion 60 is a vertically thin metal sheet. The handle 6 is thus lightweight.

The motor housing 2 integrally includes, on its outer surface, the support protrusions 63 (supports) that support the attaching portion 60 from below. The attaching portion 60 is fastened to the support protrusions 63 with screws. The attaching portion 60 can thus be attached to the motor housing 2 easily.

The attaching portion 60 has its rear edge located rearward from the rear surface of the motor housing 2. This prevents the motor housing 2 and the battery cover 13 from coming in contact with the operator.

The battery mount 11 for receiving the battery pack 12 is located on an upper portion of the motor housing 2. This structure allows easy attachment and detachment of the battery pack 12.

The battery cover 13 for covering the battery pack 12 received in the battery mount 11 from above is located on the motor housing 2 and can cover and uncover the battery mount 11. This structure protects the battery mount 11 and the battery pack 12.

The battery cover 13 has the flat foremost surface 13a (front surface) defined horizontally and vertically. The battery cover 13 can avoid obstructing the operator's field of view.

The mixer 1 according to the present embodiment includes the motor 4, the reducer 7 drivable by the motor 4, and the motor housing 2 accommodating the motor 4 and the reducer housing 3 (together referred to as the housing) accommodating the reducer 7. The mixer 1 further includes the shaft holder 108 drivable by the reducer 7 and protruding from the reducer housing 3. The mixer 1 further includes the attaching portion 60 and the joints 61 (metal members) each attached to the motor housing 2 and extending laterally, the right grip 69 located on the right end of the joint 61 and extending in the front-rear direction, and the left grip 68 located on the left end of the joint 61 and extending in the front-rear direction. The front of the motor housing 2 does not overlap the attaching portion 60 in a plan view.

In this structure, the attaching portion 60 has a central portion that does not extend frontward from the motor housing 2. This structure reliably provides visibility for the operator to easily view, for example, the blade 10 from above.

Modifications of the present embodiment will now be described.

When the controller and the motor are on the same level, the controller may not be in front of the motor horizontally. When being on the same level as the motor, the controller may be located rearward, rightward, or leftward from the motor. The controller may not extend vertically, but may extend horizontally in the front-rear and right-left directions or may be in a tilt posture. A controller including multiple circuit boards may also be located on the same level as the motor. When the motor housing can be downsized, the controller may exceed the vertical dimension of the rotational shaft.

The rotational shaft of the motor may not extend vertically. The rotational shaft may be oriented to extend horizontally in the front-rear direction or right-left direction.

The numbers and the shapes of the inlets and the outlets are not limited to those described in the above embodiment. All of the inlets and the outlets may be located on the same level. The inlets and the outlets may be vertically apart from each other.

When the controller is oriented vertically in the motor housing, the controller may not be in front of the motor, but may be rearward, rightward or leftward from the motor. A controller including multiple circuit boards may have the circuit boards each oriented vertically. The rotational shaft of the motor may not extend vertically. The numbers and the positioning of the inlets and the outlets are not limited to those described in the above embodiment.

When the inlets and the outlets are located on the same level, the numbers and the shapes of the inlets and the outlets are not limited to those described in the above embodiment. All of the inlets and the outlets may be located on the same level. At least one of the inlets may be located on the same level as at least one of the outlets. The inlets may be apart from the outlets in the circumferential direction of the motor housing.

The attaching portion of the handle may be shaped other than in a U shape. The attaching portion of the handle may be in a C shape with a middle portion between its front ends open in front of the motor housing.

To attach the handle to the motor housing, the handle may not be mounted on the supports, but may be fixed to the lower surfaces of the supports. The motor housing may include, instead of the supports, a groove along the periphery to receive the attaching portion.

The attaching portion may not be thin vertically, but may be a rod or may be a band that is radially thin.

The grips may have another shape than that described in the above embodiment. Each grip may be dividable not by a plane extending in the front-rear direction. Each grip may be an integral rod or an integral cylinder, instead of being dividable into half parts.

The arms of the joints may be separate from the attaching portion and connected to the attaching portion. Instead of the front and rear arms, a single arm may be provided to receive the grips. The joints may be eliminated, and the grips may be attached directly to the attaching portion.

The front surfaces of the motor housing and the battery cover may not be flat when the attaching portion is shaped to reliably provides the field of view. The battery cover may be eliminated.

The motor may not be a brushless motor. The inner housing in the motor housing may be eliminated to have the inlets and outlets located in the motor housing alone. The motor may be upstream in the airflow, and the controller may be downstream.

The reducer may have more or fewer shafts and gears. The positions of the shafts may be changed as appropriate. A speed change assembly may be eliminated. The position of the spindle may be changed.

The battery mount may not be located on the upper portion of the motor housing, but may be located on the side surface or the rear surface of the motor housing.

The power supply is not limited to batteries. The technique according to the present disclosure is applicable to the structure including the motor to receive utility power (alternating current or AC) with a power cable.

The length of the mixer shaft, the attaching structure for the mixer shaft attached to the spindle, as well as the shape of the blade are not limited to those described in the above embodiment.

### REFERENCE SIGNS LIST

1 mixer
2 motor housing
3 reducer housing
4 motor
5 controller
6 handle
7 reducer
8 spindle
9 mixer shaft
10 blade
11 battery mount
12 battery pack
15 bracket plate
17 inner housing
25 rotational shaft
31 fan
32 internal outlet
33 internal inlet
40 rib
41 external inlet
42 external outlet
46 control circuit board
60 attaching portion
61 joint
67A front arm
67B rear arm
68 left grip
69 right grip
70 switch
85 first shaft
86 second shaft
108 shaft holder

What is claimed is:

1. A mixer for holding a mixer shaft, the mixer comprising:
a motor including a stator and a rotor;
a motor housing accommodating the motor;
a reducer driven by the rotor;
a reducer housing below the motor housing and accommodating the reducer;
a shaft holder protruding downward from the reducer housing to hold the mixer shaft; and
a controller configured to control the motor, the controller being vertically on the same level as at least a part of the motor.

2. The mixer according to claim 1, wherein
the rotor includes a rotational shaft, and
the motor is accommodated in the motor housing with the rotational shaft extending vertically.

3. The mixer according to claim 2, wherein
the controller extends vertically in the motor housing.

4. The mixer according to claim 2, wherein
the controller is vertically within a vertical dimension of the rotational shaft.

5. A mixer for holding a mixer shaft, the mixer comprising:
a motor including a stator and a rotor;
a motor housing accommodating the motor;
a reducer driven by the rotor;
a reducer housing below the motor housing and accommodating the reducer;
a shaft holder protruding downward from the reducer housing to hold the mixer shaft; and
a controller configured to control the motor, the controller extending vertically in the motor housing.

6. The mixer according to claim 5, wherein
the rotor includes a rotational shaft, and
the motor is accommodated in the motor housing with the rotational shaft extending vertically.

7. The mixer according to claim 6, wherein
the controller is vertically within a vertical dimension of the rotational shaft.

8. The mixer according to claim 1, further comprising:
a fan rotatable together with the rotor,
wherein the motor housing includes
an inlet to draw in air in response to rotation of the fan, and
an outlet to discharge air in response to rotation of the fan, and the outlet is vertically on the same level as the inlet.

9. The mixer according to claim 8, wherein
the fan is fixed to the rotational shaft, and
the motor is accommodated in the motor housing with the rotational shaft extending vertically.

10. The mixer according to claim 8, wherein
the controller is located to receive an airflow from the inlet to the outlet.

11. The mixer according to claim 10, wherein
the motor is downstream in the airflow, and
the controller is upstream in the airflow.

12. The mixer according to claim 11, wherein
the motor and the controller are separated from each other with a rib to define the airflow.

13. The mixer according to claim 10, wherein
the controller extends vertically.

14. The mixer according to claim 8, wherein
the fan generates an airflow to move vertically along and on the controller.

15. The mixer according to claim 1, further comprising:
a battery mount on an upper portion of the motor housing to receive a battery pack.

16. The mixer according to claim 15, wherein
the motor housing further includes a battery cover to cover, from above, the battery pack attached to the battery mount.

17. The mixer according to claim 1, further comprising:
a handle attached to the motor housing.

18. The mixer according to claim 1, wherein
the reducer is configured to change a rotational speed of the shaft holder between two levels.

19. The mixer according to claim 5, further comprising:
a fan rotatable together with the rotor,
wherein the motor housing includes
an inlet to draw in air in response to rotation of the fan, and
an outlet to discharge air in response to rotation of the fan, and the outlet is vertically on the same level as the inlet.

20. A mixer for holding a mixer shaft, the mixer comprising:
a motor including a stator and a rotor;
a fan rotatable together with the rotor;
a motor housing accommodating the motor, the motor housing including
an inlet to draw in air in response to rotation of the fan, and
an outlet to discharge air in response to rotation of the fan, the outlet being vertically on the same level as at least a part of the inlet;
a reducer driven by the rotor;
a reducer housing below the motor housing and accommodating the reducer; and
a shaft holder protruding downward from the reducer housing to hold the mixer shaft.
